(19) United States
(12) Patent Application Publication
(10) Pub. No.: US 2026/0320550 A1
(43) Pub. Date: Oct. 15, 2026

(54) SYSTEM FOR POSITIONING AND PLACEMENT OF INVENTORY ITEMS FOR EFFICIENT ALLOCATION AND FULFILLMENT

(71) Applicant: Target Brands, Inc., Minneapolis, MN (US)

(72) Inventors: Sakshi Arora, Bengaluru (IN); Aashimi Bhatia, Bengaluru (IN); Aravind Govindarajan, Sunnyvale, CA (US); Achal Goyal, Udaipur (IN); Anup Kulkarni, Bengaluru (IN); Sharad Limaye, Bengaluru (IN); Rajshekhar Singhania, Bengaluru (IN); Vinayaka Yaji, Bengaluru (IN)

(21) Appl. No.: 19/644,553

(22) Filed: Apr. 10, 2026

Related U.S. Application Data
(60) Provisional application No. 63/786,579, filed on Apr. 10, 2025.

(51) Int. Cl. G06Q 10/087; G06Q 10/04; G06Q 10/0631

(52) U.S. Cl. CPC G06Q 10/08726; G06Q 10/043; G06Q 10/06315; G06Q 10/08772

(57) ABSTRACT

Methods and systems for generating an inventory positioning and placement plan are disclosed. Input data defining items, fulfillment locations, and regional demand is received, and forecasted demand is generated using distributed computing resources executing forecasting tasks in parallel. The items are transformed into a reduced set of clusters based on attribute tags including volume, location eligibility, and velocity, thereby reducing dimensionality of an optimization problem. A linear optimization model is constructed using decision variables representing allocation quantities of the clusters, with constraints derived from forecasted demand using a demand-to-inventory transformation. The model is solved to generate cluster-level allocations, which are mapped to item-level placement quantities. An inventory positioning and placement plan is then output, reducing computational resource usage relative to item-level approaches.

### CROSS-REFERENCE TO RELATED APPLICATIONS

The present application claims priority from U.S. Provisional Patent Application No. 63/786,579, filed on Apr. 10, 2025, the disclosure of which is hereby incorporated by reference in its entirety.

### BACKGROUND

With the rapid growth of online shopping and digital e-commerce, businesses have seen an increasing amount of digital and ship-to-consumer orders. To fulfill these orders, businesses not only incur the added cost of shipping packages to customers, but also enterprise computing systems must process large amounts of data including increasing numbers of orders, customer data, and additional product information in order to determine efficient placement and allocation of inventory.

A conventional approach in inventory placement and allocation is to map items, at the department level, to their default stocking locations. For example, in a large retail enterprise, a subset of items may be routed through a first warehouse to a first selection of stores, and a second (different) subset of items may be routed through a second warehouse, with some of those items retained at the warehouse, and other items routed to the same or a different selection of stores. The decisions regarding where items may be stocked can be based on historical sales levels for each individual item from retail locations. For online sales, another approach may be to place items as close to an intended sale as possible, in an attempt to reduce shipping costs. However, neither of these approaches captures true customer activity.

Additionally, in order to obtain optimized inventory placement, significant computational resources are required as there are a large number of items to be allocated to a set of potential inventory fulfillment locations and finite space into which those items are to be stored. In the context of a large retail organization, this may include hundreds of thousands of item types across a large number of item locations, which may be used to fulfill millions of online orders that are shipped from any of those fulfillment locations.

In view of the above-described network complexity and changing nature of the optimization to be achieved, conventional inventory placement systems require solving such optimization problems with extremely high dimensionality, including hundreds of thousands of items, thousands of demand locations, and multiple fulfillment nodes. Direct formulation of such problems results in optimization models with billions of variables and constraints that are computationally intractable for conventional computing systems, often exceeding memory limits and execution time constraints of available hardware. Given the ever-changing nature of product assortments and demand shirts, accurate, up-to-date solutions are often lacking, leading to significant network inefficiencies, inefficient placement and/or allocation of items, and significant work in recomputation of revised solutions.

Additionally, conventional approaches that attempt to reduce dimensionality through naive aggregation or heuristic simplifications result in loss of solution fidelity, instability in generated plans, or inability to incorporate real-world constraints such as throughput, storage capacity, and item co-ordering behavior.

### SUMMARY

In general, the subject matter of this disclosure relates to systems and methods for positioning and placement of inventory items for efficient allocation and fulfillment.

In a first aspect, methods for generating an inventory positioning and placement plan are disclosed. In an example, a computer-implemented method includes receiving input data defining a set of items, a set of fulfillment locations, and demand data associated with a plurality of geographic regions. The method further includes generating forecasted demand for the set of items at the plurality of geographic regions by distributing forecasting tasks across a plurality of computing systems executing in parallel. The method further includes transforming the set of items into a reduced set of item clusters based on combinations of attribute tags including at least volume, location eligibility, and velocity derived from the forecasted demand, thereby reducing a dimensionality of an optimization problem. The method further includes defining one or more decision variables representing allocation quantities of the reduced set of item clusters between fulfillment locations and geographic regions. The method further includes constructing a linear optimization model including the decision variables, one or more constraints including throughput constraints and storage capacity constraints derived from forecasted demand using a demand-to-inventory transformation, and an objective function based at least in part on a distance-based cost metric. The method further includes solving the linear optimization model to generate cluster-level allocation quantities. The method further includes mapping the cluster-level allocation quantities to item-level placement quantities using a declustering process, and outputting an inventory positioning and placement plan. In some embodiments, transforming the set of items into the reduced set of item clusters reduces computational resource utilization associated with solving the linear optimization model.

In a second aspect, computing systems for generating an inventory positioning and placement plan are disclosed. An example system includes at least one processor and at least one memory storing computer-executable instructions that, when executed, cause the computing system to receive input data defining a set of items, a set of fulfillment locations, and demand data associated with a plurality of geographic regions. The computing system is further configured to generate forecasted demand by distributing forecasting tasks across a plurality of computing systems executing in parallel, and to transform the set of items into a reduced set of item clusters based on combinations of attribute tags including at least volume, location eligibility, and velocity, thereby reducing a dimensionality of an optimization problem. The computing system is further configured to define decision variables representing allocation quantities of the reduced set of item clusters between fulfillment locations and geographic regions, construct a linear optimization model including the decision variables and one or more constraints derived from forecasted demand using a linear approximation of inventory levels, and solve the linear optimization model to generate cluster-level allocation quantities. The computing system is further configured to map the cluster-level allocation quantities to item-level placement quantities and output an inventory positioning and placement plan, wherein the transformation of the set of items into the reduced set of item clusters reduces computational complexity relative to an item-level optimization model.

In a third aspect, platforms for generating an inventory positioning and placement plan are disclosed. An example platform includes a computing device, a plurality of data storages, and a network server in communication with the computing device and the plurality of data storages. The computing device is configured to receive input data defining a set of items, a set of fulfillment locations, and demand data associated with a plurality of geographic regions, generate forecasted demand using distributed computing resources executing forecasting tasks in parallel, and transform the set of items into a reduced set of item clusters based on combinations of attribute tags to reduce dimensionality of an optimization problem. The computing device is further configured to construct and solve a linear optimization model defined using decision variables representing allocation quantities of the reduced set of item clusters, generate cluster-level allocation quantities, map the cluster-level allocation quantities to item-level placement quantities, and output an inventory positioning and placement plan. In some embodiments, the platform reduces memory usage and execution time associated with solving the optimization model relative to an item-level formulation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example system for optimizing positioning and placement of inventory items, according to an example.

FIG. 2 illustrates an example use case for optimizing inventory positioning, according to an example.

FIG. 3 illustrates an example use case for optimizing inventory placement, according to an example.

FIG. 4 illustrates an example schematic graphic representation of optimized positioning and placement of inventory items based on customer demand, according to an example.

FIG. 5 illustrates an example of a system architecture for parallel demand forecasting, according to an example.

FIG. 6 illustrates an example schematic of a clustering algorithm, according to an example.

FIG. 7 illustrates an example architecture of an optimization model, according to an example.

FIG. 8 illustrates an example method for optimizing positioning and placement of inventory items, according to an example.

FIG. 9 illustrates an example block diagram of a computing system for executing all or part(s) of the system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “having,” and “has” are interchangeable and not intended to be limiting. The term “such as” also is not intended to be limiting. For example, the term “including” shall mean “including, but not limited to.”

All ranges provided herein include the upper and lower values of the range unless explicitly noted. Although values are disclosed herein when disclosing certain exemplary embodiments, other embodiments within the scope of the pending claims can have values other than the specific values disclosed herein or values that are outside the ranges disclosed herein.

Terms such as “substantially” or “about” when used with values or structural elements provide a tolerance that is ordinarily found during testing and production due to variations and inexact tolerances in factor such as material and equipment.

As briefly described above, embodiments of the present disclosure are directed to a improvements in the computing systems usable for optimizing inventory placement allocation across an enterprise fulfillment network to improve processing speed without sacrificing accuracy. Specifically, the present disclosure relates to an improved processing pipeline and associated optimization model usable for generating an optimized inventory positioning and placement plan for inventory items. The present disclosure addresses the technical problem of how to transform a large-scale, high-dimensional optimization problem into a computationally tractable form that can be executed efficiently on distributed computing systems while preserving solution quality and enabling incorporation of complex constraints.

In examples, a model usable to obtain item fulfillment solutions implements a clustering approach based on multiple dimensions including item volume classes, location eligibility, product pyramid, and item velocity values. The clustering groups items based on these attributes, e.g., if they share attributes (e.g., tags) across these dimensions. For example, two items having a common item volume or velocity may be clustered to be handled similarly, while items that perform dissimilarly might not be clustered together. This clustering based on tags defining item behavioral attributes enables simplification of the optimization problem, reduces computational complexity, and saves computational resources because each individual item does not have to processed independently.

In example applications, the problem to be addressed involves optimization of item localization, to specifically stage items at appropriate locations for efficient fulfillment while adhering to business constraints. Constraints involved include building volume constraints, throughput processing capacity at each location, item eligibility restrictions, upstream inventory availability, item affinity (items commonly ordered together) and week-to-week consistency of orders. In some instances, the model used for obtaining a fulfillment solution may be implemented as a linear optimization model that uses (1) tag-based clustering to make the problem more solvable, (2) incorporates business flexibility through customizable constraints, (3) considers item affinities, and (4) allows for network configuration through the tag-cluster-level constraints. The model minimizes a weighted combination of total shipping distance, an unfulfilled demand penalty, and volume utilization, while accounting for throughput, volume, fulfillment, and exclusion constraints.

The disclosed system provides an improved technical solution by transforming item-level optimization variables into cluster-level decision variables using structured tag-based clustering, and reducing dimensionality of the optimization problem while preserving constraints. The solution also improves upon existing approaches by converting nonlinear inventory constraints into linear approximations compatible with linear programming solvers, and distributing demand forecasting computations across multiple computing systems for parallel execution.

These techniques improve the functioning of computing systems by reducing memory usage, reducing execution time, and enabling solution of optimization problems that would otherwise be computationally infeasible.

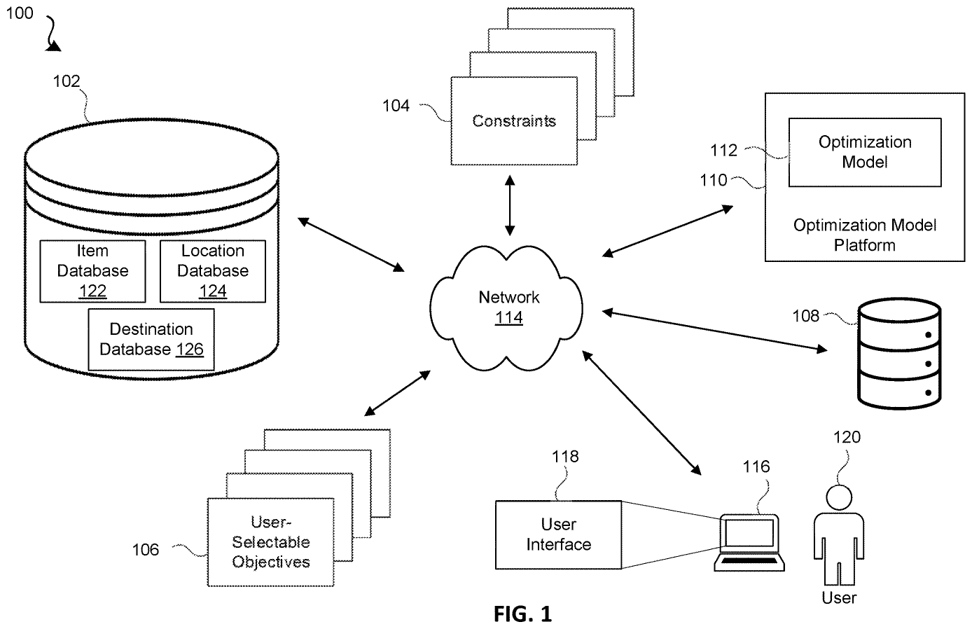

These and other examples will be explained in more detail below with respect to FIG. 1-FIG. 9.

FIG. 1 illustrates an example system 100 for generating an optimized inventory positioning and placement plan. In some examples, the devices, applications, and systems of system 100 are configured to send and receive data via a network 114. In some examples, as described herein, network 114 may include a computer network, an enterprise intranet, the Internet, a LAN, a Wide Area Network (WAN), wireless transmission mediums, wired transmission mediums, other networks, and combinations thereof. Although network 114 is shown as a single network in FIG. 1, this is shown as an example, and the various communications described herein may occur over the same network or a number of different networks.

In examples, an enterprise (for example, a retail enterprise) may provide various items (i.e. goods) for sale to customers. The items may, for example, be stored in a variety of warehouses, fulfillment centers, and/or retail locations. Items ordered by customers can be shipped directly to destinations from the warehouses, fulfillment centers and/or the retail locations, depending on circumstances. In some examples, system 100 includes a central database 102. Central database 102 may include multiple databases. For example, central database 102 may include an item database 122, a location database 124, and a destination database 126.

The item database 122 includes the items offered for sale by the retail enterprise. The location database 124 includes locations from which the items may be shipped. For example, the location database 124 includes the locations of warehouses, fulfillment centers, and/or retail locations that may ship the items to customers. The destination database 126 includes the destinations to which the items may be shipped. For example the destination database 126 may include customers' home locations, business locations, and the like.

The central database 102, the item database 122, the location database 124, and the destination database 126 as described herein may, in some examples, be separate or may be completely or partially combined. The central database 102, the item database 122, the location database 124, and the destination database 126 as described herein may, in some examples, be separate or may include other databases and/or may represent a portion of another database. The central database 102, the item database 122, the location database 124, and the destination database 126 as described herein may include cloud storage, relational databases, block storage, distributed computing, SQL storage, columnar storage, hybrid storage, document storage, file storage, centralized databases, multimodal databases, and/or other suitable database types.

The system 100, in some examples, includes constraints 104 such as throughput, volume, and specialized item handling. For example, a throughput constraint may be associated with a fulfillment center representing the maximum number of units a fulfillment center may process and/or ship in a given time period (e.g., daily, weekly, monthly). The throughput constraint is based at least in part on factors such as labor availability and physical capacity. The volume constraint, for example, is based at least in part on the cubic volume limitations of the fulfillment center for storage as the total cubic volume of items placed at any fulfillment center cannot exceed the available storage capacity. The specialized item handling constraint, for example, is based at least in part on fulfillment centers having physical limitations related to processing and storing specific items or specialized handling capabilities. For example, some fulfillment centers may not have refrigeration storage, and therefore, cannot store and process perishable items.

The system 100, in some examples, includes user-selectable objectives 106. The user-selectable objectives 106 allow for balancing competing goals and incorporating strategic priorities. The user-selectable objectives 106 include, for example, shipping expense minimization, delivery time minimization, and space utilization maximization. For example, shipping expense minimization attempts to reduce total shipping costs by placing inventory closer to demand sources, delivery time minimization optimizes for faster expected delivery dates to guests by placing items at nearby fulfillment centers, and space utilization maximization efficiently uses available warehouse capacity.

The system 100 further includes a plurality of interconnected computing systems 108. In some examples, execution jobs may be distributed to the plurality of interconnected computing systems 108 to generate forecasted demands for items in the inventory collection at varying temporal granularities in parallel. In some examples, the temporal granularities may include daily, weekly, monthly, and the like. In some embodiments, the plurality of interconnected computing systems 108 are configured to execute demand forecasting tasks in parallel by partitioning forecasting workloads across items, geographic regions, and time granularities. Such distributed execution reduces processing latency and enables scalable computation for large datasets.

The system 100 also includes an optimization model platform 110 for building and hosting an optimization model 112. In some examples, the optimization model 112 generates an optimized inventory positioning and placement plan. For example, the positioning and placement plan may specify the type and quantity of items to be placed in each fulfillment center. In some embodiments, the optimization model platform 110 is configured to transform item-level data into cluster-level representations prior to optimization, thereby reducing a dimensionality of the optimization problem. This transformation reduces the number of decision variables required for solving the optimization model and enables efficient execution using available computing resources.

In some embodiments, the optimization model 112 is formulated as a constrained optimization problem. In an example implementation, the optimization model is expressed as a linear program. An example structure of such an optimization model may be defined as follows:

### Let:

i∈I denote an item cluster;
j∈L denote a source location;
k∈R denote a demand region.
   A decision variable xᵢⱼₖ represents a quantity of demand associated with cluster i that is fulfilled from location j to region k.
   In some embodiments, the optimization model minimizes a weighted objective function:

$$min {\sum }_{i ∈ I} {\sum }_{j ∈ L} {\sum }_{k ∈ R} {d}_{j k} \cdot {x}_{ijk} + {λ}_{1} \cdot U ( x ) - {λ}_{2} \cdot A ( x )$$

where:
dⱼₖ represents a distance or cost metric between location j and region k;
U(x) represents a penalty associated with unfulfilled demand;
A(x) represents an affinity-based reward for co-locating related items;
λ₁, λ₂ are weighting parameters.

In some embodiments, the optimization model 112 uses a set of constraints. Example constraints may include a demand fulfillment constraint, a throughput constraint, a volume constraint, and an eligibility constraint. Each of these constraints may be formulated as follows:
Demand fulfillment constraint:

$${\sum }_{j ∈ L} {x}_{ijk} = {D}_{ik} , ∀ i , k$$

Throughput constraint:

$${\sum }_{i ∈ I} {\sum }_{k ∈ R} {x}_{ijk} \leq {T}_{j} , ∀ j$$

Volume constraint:

$${\sum }_{i ∈ I} {\sum }_{k ∈ R} {v}_{i} \cdot {x}_{ijk} \leq {C}_{j} , ∀ j$$

Eligibility constraint:

xᵢⱼₖ=0 if cluster i is not eligible at location j

In some embodiments, inventory levels are not directly modeled as independent variables. Instead, inventory levels are approximated based on forecasted demand. For example, an inventory level for cluster i at location j may be estimated as:

Inventoryᵢⱼ=Demandᵢⱼ×Wᵢ

where Wᵢ represents a configurable weeks-of-supply parameter.
The estimated inventory level may then be converted into a volume requirement using:

Volumeᵢⱼ=Inventoryᵢⱼ×vᵢ

where vᵢ represents a unit volume associated with cluster i.
This transformation enables incorporation of inventory-based constraints into a linear optimization model.

In some embodiments, one or more of the above-defined constraints are approximated to maintain linearity of the optimization model. For example, nonlinear relationships between demand, inventory levels, and storage capacity may be approximated using linear relationships based on forecasted demand and configurable supply parameters. Such linear approximations enable the optimization problem to be solved efficiently using linear programming techniques while preserving acceptable accuracy.

In some examples, an enterprise user 120 may review and/or update/modify the optimized inventory positioning and placement plan at a user interface 118 of a user device 116. In an example, user interface 118 is a web application. In other examples, user interface 118 is a device application. User interface 118 may be presented to the enterprise user 120 via a display of device 116. In some examples, device 116 may be a desktop computer, a laptop computer, a tablet, a cell phone, a smart TV, a smart wearable device, or other appropriate electronic device which is capable of displaying and facilitating interaction with the user interface 118.

In examples, the enterprise user 120 may utilize the user interface 118 to view and/or interact with a dashboard that depicts outputs, results, metrics, and/or other information regarding the optimization model 112 and its predictions.

In some embodiments, data retrieved from the item database 122, location database 124, and destination database 126 is transformed into structured inputs for the optimization model, including region-level demand values, cluster-level item representations, and constraint parameters associated with fulfillment locations. These transformed inputs are provided to the optimization model platform 110 for constructing and solving the optimization model.

In some embodiments, the system 100 is configured to execute an end-to-end data processing pipeline in which demand forecasting is performed using the plurality of interconnected computing systems 108 to generate region-level demand data, and items are transformed into cluster-level representations using tag-based clustering. The system constructs a reduced-dimensional optimization model, which is solved using the optimization model platform 110. Resulting cluster-level outputs are mapped to item-level placement and positioning decisions. This pipeline enables transformation of high-dimensional input data into a computationally tractable representation suitable for large-scale optimization.

In some embodiments, the system 100 improves operation of computing systems by reducing computational complexity of large-scale optimization problems through clustering-based dimensionality reduction, enabling use of linear optimization techniques through transformation of input data and constraints, and distributing computational workloads across multiple computing systems. These improvements enable solving optimization problems that are otherwise computationally infeasible using conventional item-level approaches.

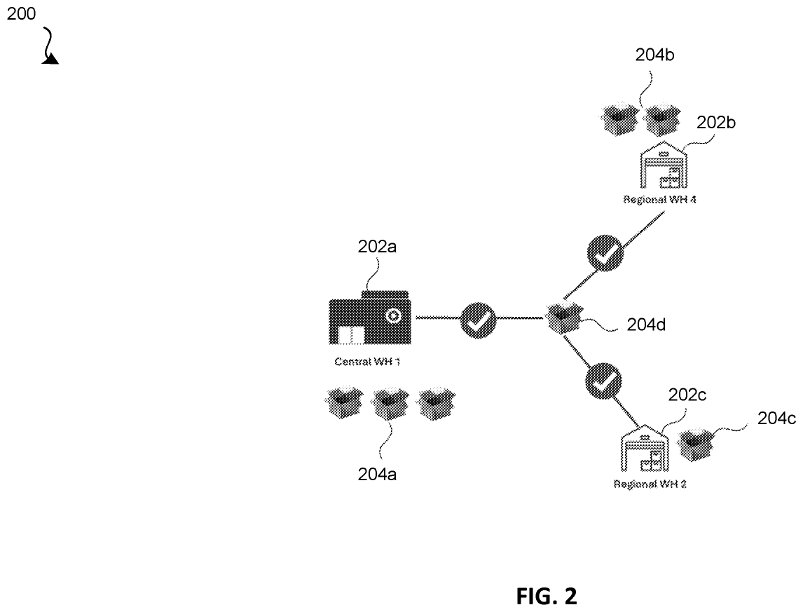

FIG. 2 illustrates an example use case 200 for optimizing inventory positioning. In use case 200, inventory positioning requires computational decision making regarding the quantity of items to be stored at respective locations. Use case 200 includes locations 202a, 202b, and 202c, and inventory items 204a, 204b, 204c, and 204d.

In some examples, the locations 202a, 202b, and 202c may be fulfillment centers, central warehouses, regional warehouses, retail store locations, and the like. Inventory items 204a, 204b, 204c, and 204d may include items offered for sale by the retail enterprise.

In use case 200, inventory item 204d is required to be stored in one of the locations 202a, 202b, and 202c. The system may, for example, determine which location of the locations 202a, 202b, and 202c is/are available for storing inventory item 204d. This determination may be based on various characteristics related to the locations 202a, 202b, and 202c including, although not limited to, the throughput capacity and volume capacity. Inventory positioning may also be based on item characteristics of the of the inventory item 204d such as the item volume, and item velocity. In use case, 204d the system has determined that the inventory item 204d may be positioned at any one of the locations 202a, 202b, and 202c.

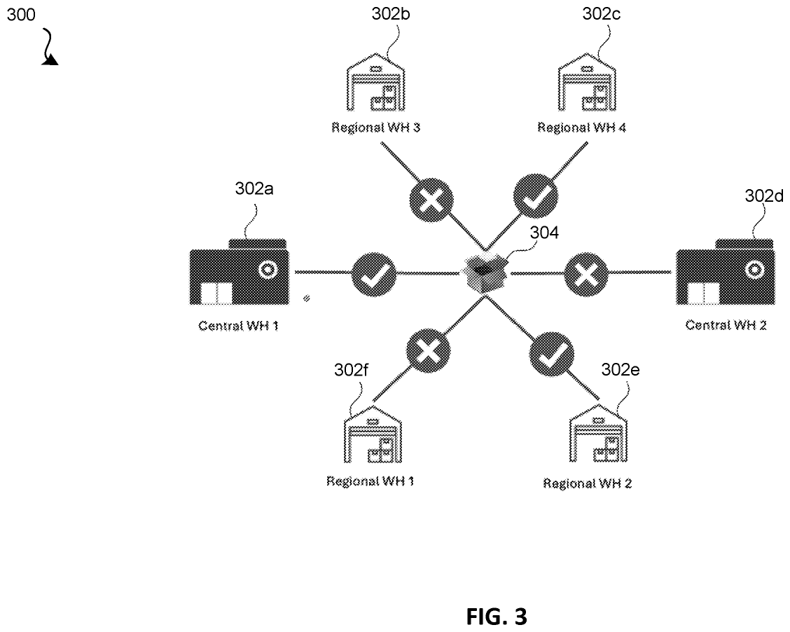

FIG. 3 illustrates an example use case 300 for optimizing inventory placement. In use case 300, inventory placement requires computational decision making regarding which inventory items may be stored at respective locations. Use case 300 includes a plurality of locations 302a, 302b, 302c, 302d, 302d, 302e, and 302f and an inventory item 304.

In some examples, the locations 302a, 302b, 302c, 302d, 302e, and 302f may be fulfillment centers, central warehouses, regional warehouses, retail store locations, and the like. Inventory item 304 may include items offered for sale by the retail enterprise.

In use case 300, inventory item 304 is required to be stored in one of the locations 302a, 302b, 302c, 302d, 302e, and 302f. The system may, for example, determine which locations of locations 302a, 302b, 302c, 302d, 302e, and 302f is/are available for storing inventory item 304. This determination may be based on various characteristics related to the locations 302a, 302b, 302c, 302d, 302e, and 302f including, although not limited to, the throughput capacity, volume capacity, and specialized item handling capability. Inventory placement may also be based on item characteristics of the of the inventory item 304 such as the item volume, item velocity, and item category.

Inventory placement may also be based on item characteristics of the inventory item 304 such as the item volume, item velocity, and item category. In use case 300, the system has determined that the inventory item 304 may be positioned at any of the locations 302a, 302c, and 302e.

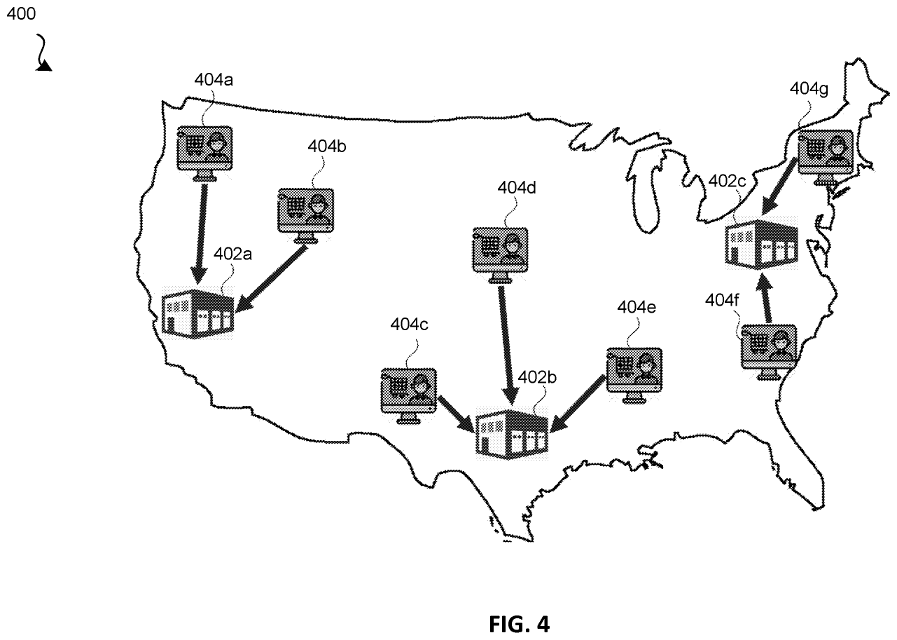

FIG. 4 illustrates an example schematic graphic representation 400 of optimized positioning and placement of inventory items based on customer demand. In the schematic graphic representation 400, a plurality of fulfillment centers 402a, 402b, and 402c are positioned at various geographic locations. In some examples, the fulfillment centers 402a, 402b, and 402c may be central warehouses, regional warehouses, retail locations, and the like. The schematic graphic representation 400 also includes a plurality of customer demand points representing ship-to-home order destinations 404a, 404b, 404c, 404d, 404e, 404f, and 404g. In some examples the ship-to-home order destinations 404a, 404b, 404c, 404d, 404e, 404f, and 404g may include although not limited to customers' homes and businesses. In the schematic graphic representation 400, the inventory positioning and placement has been allocated across the fulfillment centers 402a, 402b, and 402c to minimize total shipping costs to the distributed customer demand points representing ship-to-home order destinations 404a, 404b, 404c, 404d, 404e, 404f, and 404g.

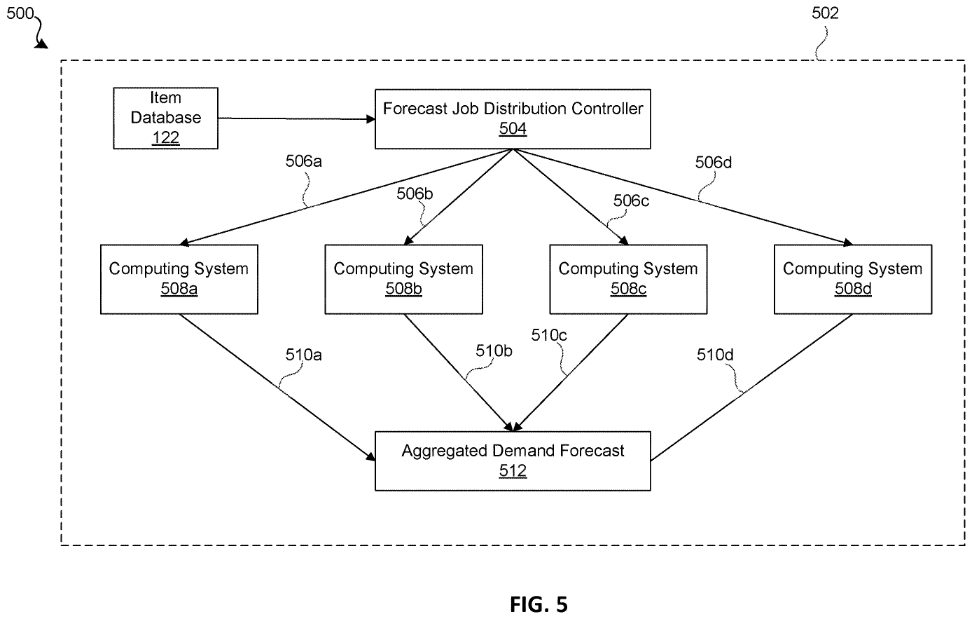

FIG. 5 illustrates an example system architecture 500 for generating forecasted demand using parallel processing across a plurality of computing systems. In some embodiments, the system architecture 500 is configured to decompose a large-scale demand forecasting problem into a plurality of independent execution jobs that are processed concurrently, thereby reducing overall computation time and enabling scalable processing of large item datasets.

In some embodiments, demand forecasting is performed prior to optimization and provides input demand values for each item cluster and geographic region. The architecture 500 includes, in the example shown, a parallel execution module 502, a forecast job distribution controller 504, a plurality of computing systems 508a-508d, and an aggregated demand forecast module 512.

In some examples, the parallel execution module 502 includes the forecast job distribution controller 504, which is configured to partition forecasting tasks into multiple execution jobs. In some embodiments, the controller receives item data from item database 122, and partitions the forecasting workload based on one or more dimensions, including subsets of items, geographic regions, and/or time granularities (e.g., daily, weekly, monthly). Each partition corresponds to an execution job 506a-506d.

In some examples, the parallel execution module 502 also includes a plurality of computing systems 508a, 508b, 508c, and 508d, and an aggregated demand forecast 512. In some embodiments each computing system includes one or more processors and memory resources, and the computing systems may be distributed across a cluster computing environment or cloud infrastructure. Each computing system 508a-d executes one or more forecasting algorithms to generate demand predictions. In some examples, forecasting algorithms may include statistical models, machine learning models, or time-series forecasting models, and different computing systems may process different time granularities (e.g., weekly vs. monthly forecasts) in parallel.

In some examples, the forecast job distribution controller 504 distributes the plurality of execution jobs 506a, 506b, 506c, 506d to a plurality of computing systems 508a, 508b, 508c, 508d, where each execution job is configured to calculate a forecasted demand for one or more items in the set of items at a regional level. In particular, each execution job represents a computational task configured to generate demand forecasts for a subset of the problem space. In some embodiments, each execution job processes a subset of items or clusters, a subset of geographic regions, and/or a specific time horizon or granularity. Execution jobs are independent and can be processed in parallel without interdependency.

In some examples, the parallel execution module 502 may include additional computing systems. In some examples, additional execution jobs may be sent to the additional computing systems. In other examples, fewer computing systems and execution jobs may be included in the parallel execution module 502. In other examples, multiple execution jobs may be sent to a given computing system.

The computing systems 508a, 508b, 508c, 508d may execute the assigned execution jobs 506a, 506b, 506c, 506d in parallel. Each computing system 508a, 508b, 508c, 508d processes a demand forecast for varying time granularities in parallel including, but not limited to daily, weekly, fortnightly, and monthly time periods. In some examples, each computing system 508a, 508b, 508c, 508d may process demand calculations for one or more geographic regions. In some examples, the regional level may be associated with a predefined geographic areas such as states, metropolitan areas, zip code clusters, custom-defined market regions, and the like. In some embodiments, demand is aggregated at a regional level to reduce computational complexity. Regions may be defined based on geographic proximity, demand density, or proximity to fulfillment locations. Aggregating demand at the regional level reduces the dimensionality of the optimization problem while maintaining sufficient fidelity for accurate planning.

Each computing system generates forecasted demand values for assigned items and regions. In some embodiments, forecast outputs correspond to demand values Dᵢₖ, where i represents an item or item cluster and k represents a geographic region. Forecasts may be generated for multiple future time periods. The results of each execution job are output as forecasted demand results 510a-510d.

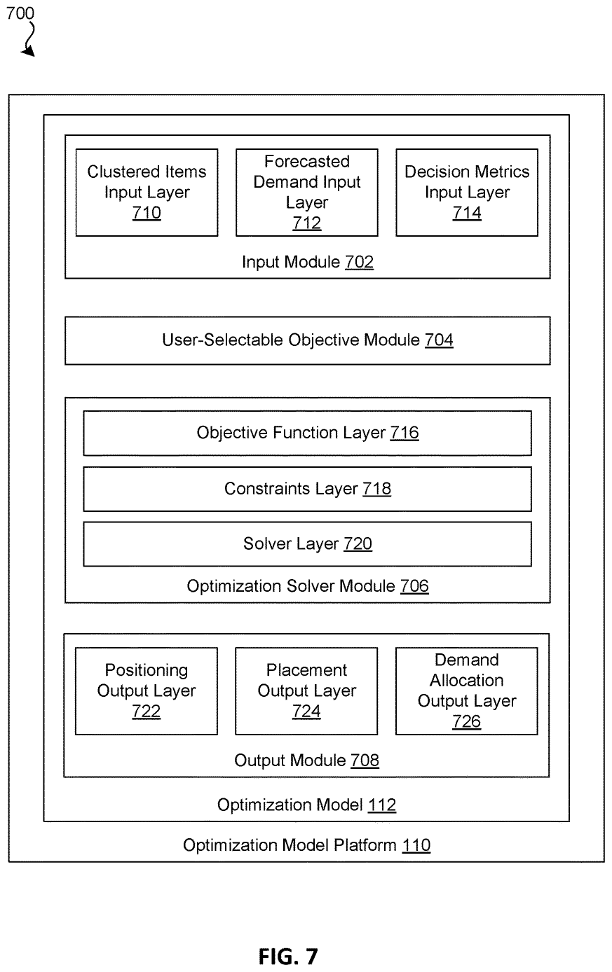

The aggregated demand forecast module 512 is configured to combine outputs from the plurality of computing systems. In some embodiments, forecast results from multiple execution jobs are aggregated into a unified dataset. Aggregation may include summation across sub-regions, reconciliation of overlapping forecasts, and/or alignment across time granularities. The aggregated output provides region-level demand forecasts used as input to the optimization model described in FIG. 7.

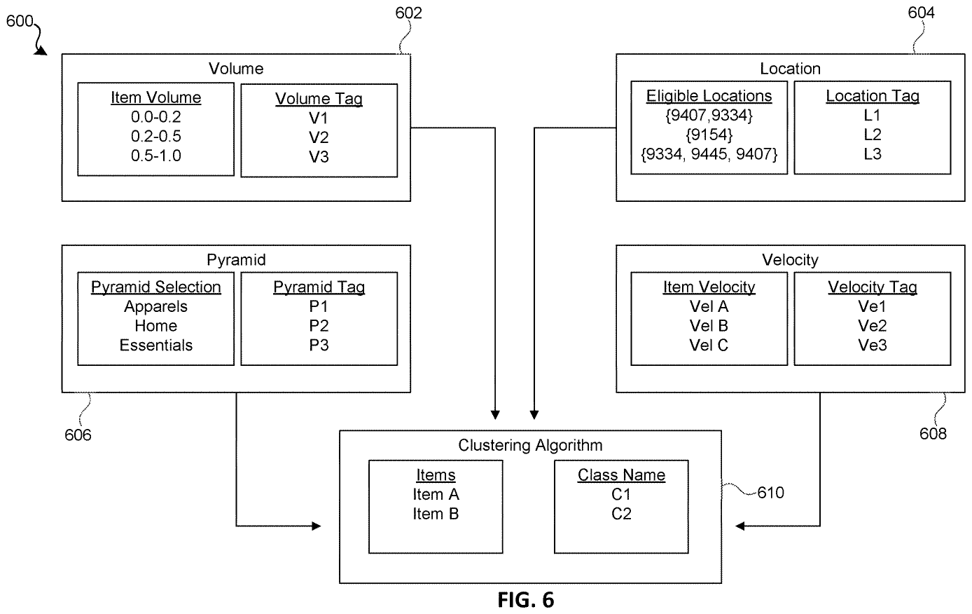

In some embodiments, item-level forecasts may be mapped to cluster-level demand values based on clustering results (FIG. 6). The resulting demand values Dᵢₖ are used as inputs to decision variables xᵢⱼ in the optimization model.

In some embodiments, the architecture 500 provides technical advantages including reducing end-to-end forecasting latency through parallel execution, enabling scalable processing of large datasets involving hundreds of thousands of items, and distributing computational workload across multiple computing systems to avoid resource bottlenecks.

FIG. 6 illustrates an example clustering architecture 600 for grouping inventory items into clusters used in the optimization model. In some embodiments, the clustering architecture 600 is configured to transform a high-dimensional item-level dataset into a reduced set of cluster-level representations that preserve attributes relevant to optimization constraints.

In some examples inventory items sold by the retail enterprise receive tags across four dimensions: a volume dimension 602, a location dimension 604, a pyramid dimension 606, a velocity dimension 608. Each item is represented by a multidimensional tag vector:

Tᵢ=(Vᵢ,Lᵢ,Pᵢ,Veᵢ)
where:
Vᵢ is a volume tag,
Lᵢ is a location eligibility tag,
Pᵢ is a product category tag, and
Veᵢ is a velocity tag derived from forecasted demand.
   In some examples, the inventory items and associated tags are input into a clustering algorithm 610.

In some examples, the volume dimension 602 applies tags to an item to assign the item to a discrete volume class based on physical size. In some embodiments, volume classes correspond to predefined cubic volume ranges. The volume tag is used to approximate storage requirements in the optimization model. In a particular implementation, the volume dimension 602 includes seven volume tags based on cubic feet of an item including: V1: 0.0-0.2 cu.ft (very small items), V2: 0.2-0.5 cu.ft (small items), V3: 0.5-1.0 cu.ft (medium-small items), V4: 1.0-1.8 cu.ft (medium items), V5: 1.8-2.5 cu.ft (medium-large items), V6: 2.5-4.0 cu.ft (large items), and V7: >5.0 cu.ft (very large items). In other examples, additional volume tags may be included in the volume dimension 602. In some examples, fewer volume tags may be included in the volume dimension 602. In some examples, the volume ranges associated with each volume tag may be increased or decreased. The volume dimension 602 assigns a volume tag to the inventory items.

In some examples, the location dimension 604 includes a location tag that characterizes items based on based on eligible fulfillment centers where the item may be placed. Each item is assigned a location eligibility tag representing a set of fulfillment locations at which the item may be stored or processed. In some embodiments, the tag encodes a set-valued attribute (e.g., a list of eligible fulfillment centers). This dimension ensures that clustering preserves feasibility constraints.

For example, a perishable may only be placed at a fulfillment center with refrigeration storage. For example, the location tags may include: L1: {9407, 9334} (indicating that the item may be placed at fulfillment centers 9407 or 9334); L2: {9154} (indicating that the item may be placed at fulfillment center 9154); L3: {9334, 9445, 9407} (indicating that the item may be placed at fulfillment centers 9334, 9445, or 9407); and L4, L5, L6: (indicating other location combination sets of fulfillment centers where the item may be placed). The location dimension 604 assigns a location tag to the inventory items.

In some examples, the pyramid dimension 606 includes a pyramid tag that is associated with an item category selection. Each item is assigned a category-based tag corresponding to a product classification, which enables enforcement of business rules and category-specific handling constraints. The item category selection may include apparels, home, essentials, and the like. For example, the pyramid tag may include: P1 (corresponding to apparel items); P2 (corresponding to home items); and P3 (corresponding to essential items). In some examples, additional pyramid tags associated with additional categories may be included. The pyramid dimension 606 assigns a pyramid tag to the inventory items.

In some examples, the velocity dimension 608 includes a velocity tag that is associated with an item velocity, e.g., based on forecasted demand. In some embodiments, velocity is derived from region-level demand forecasts generated in FIG. 5. Velocity classification enables clustering of items with similar demand behavior. The item velocity may include, although not limited to, Vel A, Vel B, and Vel C. For example, the velocity tags may include: Ve1 (corresponding to Vel A); Ve2 (corresponding to Vel B); and Ve3 (corresponding to Ve3). In some examples, additional velocity tags associated with additional item velocities may be included. In some examples, the velocity tag may be based at least in part on the forecasted demand for the item. The velocity dimension 608 assigns a velocity tag to the inventory items.

The inventory items with an associated volume tag, location tag, pyramid tag, and velocity tag are input to a clustering algorithm 610. In some examples, the clustering algorithm 610 uses a tag-based approach to group items with similar characteristics. In some examples, items with one or more identical tags are clustered together. In other examples, items with identical tag combinations are clustered together. In some examples, by clustering items with identical tags similar volume items cluster together, items with same eligible locations cluster together, same product categories remain clustered, and same velocity items cluster together.

In a particular implementation, the clustering algorithm 610 groups items into clusters based on their tag vectors. In some embodiments, a cluster Cₘ is defined as:

Cₘ={i|Tᵢ=Tₘ}

That is, items are grouped into the same cluster if they share identical or substantially similar tag vectors across selected dimensions.

In some embodiments, clustering includes tag vector generation for each item, grouping items by identical tag combinations, and optionally merging clusters based on similarity thresholds to control cluster granularity. In particular, a number of clusters may be adjusted by modifying tag resolution (e.g., number of volume bins), relaxing matching criteria (e.g., allowing partial matches), and/or applying merging rules based on similarity metrics. This enables a tradeoff between computational efficiency and optimization accuracy.

In example implementations, the clustering algorithm outputs a set of clusters C={C₁, C₂, . . . , C_{M}}, as well as cluster-level attributes, including aggregated demand, representative volume, and eligibility constraints. Each cluster is treated as a unit of decision-making in the optimization model. That is, each cluster may correspond to an index i in the decision variable xᵢⱼₖ described in FIG. 7. The clustering therefore reduces the number of decision variables from item-level to cluster-level, with cluster attributes used to define constraints and objective function components. In some embodiments, clustering is constrained such that items within a cluster share identical eligibility constraints, thereby ensuring that cluster-level optimization decisions remain feasible at the item level without requiring post-optimization feasibility correction.

FIG. 7 illustrates an example architecture 700 of an optimization model 112 for generating an optimized inventory positioning and placement plan. In some embodiments, the optimization model 112 is implemented as a modular system executed by one or more computing systems and includes an input module 702, a user-selectable objective module 704, an optimization solver module 706, and an output module 708. The architecture is configured to transform high-dimensional item-level data into a reduced-dimensional optimization problem and generate item-level placement decisions.

In some examples, the input module 702 is configured to receive and preprocess data for the optimization model 112. The input module 702 may include a clustered items input layer 710, a forecasted demand input layer 712, and a decision metrics input layer 714.

The clustered items input layer 710 receives the clusters of items to be processed by the optimization model 112. Each cluster represents a group of items sharing attribute tags across multiple dimensions, including, e.g., volume classification, location eligibility, product category, and velocity classification derived from forecasted demand. Clustering reduces the dimensionality of the optimization problem by replacing item-level representations with cluster-level representations.

The forecasted demand input layer 712 receives the item-level demand forecasts at for varying time granularities. In examples, the forecasted demand input layer 712 receives demand forecasts generated at a regional level. In some embodiments, demand forecasts are generated using parallel execution across multiple computing systems, and demand is aggregated from finer-grained data (e.g., zip code level) into regions. An input represents demand Dᵢₖ for each cluster i and region k.

The decision metrics input layer 714 receives various decision metrics representing the amount of a given cluster to be transferred from a given fulfillment center to a given destination, and defines decision variables used in the optimization model. In some embodiments, each decision variable xᵢⱼₖ represents a quantity of demand associated with cluster i fulfilled from location j to region k, and decision variables are defined at the cluster level to reduce computational complexity relative to item-level formulations.

In some examples, the user-selectable objective module 704 receives one or more user-selectable objectives 106. In some examples, the user-selectable objectives 106 include minimizing shipping cost/distance, minimizing delivery times, and maximizing space utilization. In other examples, additional user-selectable objectives 106 may available for selection. For example, minimizing shipping cost reduces the total distance that items must be shipped from fulfillment centers to customer destinations, minimizing delivery times reduces the time required to deliver items from fulfillment centers to customers by placing inventory closer to customer demand locations, and maximizing space utilization optimizes the use of available cubic volume capacity at fulfillment centers by efficiently allocating inventory within the physical space constraints of each facility. In some examples, multiple user-selectable objectives 106 may be selected, and in other examples, only one may be selected.

In some embodiments, the user-selectable objective module 704 enables definition of objectives include minimizing shipping distance, minimizing delivery time, and maximizing storage utilization. Multiple objectives are combined using a weighted scoring function. In some examples, the objective function includes a distance-based cost component dⱼₖ·xᵢⱼₖ, a penalty term for unmet demand, and an affinity-based reward term that promotes co-location of frequently co-ordered items. Weights associated with each component may be configurable via a user interface.

In some embodiments, item affinity is determined using a predictive model that estimates a likelihood that two or more items are co-ordered within a transaction. The predicted affinity values may be incorporated into the optimization model as a reward term in the objective function that encourages co-location of frequently co-ordered items, and/or constraints that promote grouping of items within the same fulfillment location. This improves package consolidation and reduces shipping costs.

In some examples, the optimization solver module 706 includes an objective function layer 716, a constraints layer 718, and a solver layer 720, where these layers work together to determine optimal inventory placement and positioning decisions.

In some examples, the objective function layer 716 scores, using a scoring function, the user-selectable objectives 106 input at the user-selectable objective module 704 in order to balance competing goals. The scoring function assigns a score to reward placement of items that aligns with the business priorities. For example, if minimizing total shipping distance is selected as the user-selectable objective, then a score is assigned to reward placement and positioning that align with item affinity, upstream availability, product categories, and item velocity. In some examples, the scoring function penalizes unmet demand to ensure that all customer demand is filled.

For example, the objective function layer 716 may construct the objective function using inputs from the objective module 704. In some embodiments, the objective function is defined as:

$$min {\sum }_{i} {\sum }_{j} {\sum }_{k} {d}_{j k} \cdot {x}_{ijk} + {λ}_{1} \cdot U ( x ) - {λ}_{2} \cdot A ( x )$$

The objective balances cost minimization, demand fulfillment, and item affinity.

In some examples, the constraints layer 718 enforces the limitations and constraints 104 of the fulfillment centers that the placement and positioning. The constraints 104 include throughput, volume, and specialized item handling. In particular examples, such constraints may include throughput constraints, formulated as follows:

$${\sum }_{i} {\sum }_{k} {x}_{ijk} \leq {T}_{j}$$

Additionally, volume constrains may be determined by using inventory approximated from demand, and then converted to volume:
Inventory approximated from demand:

Inventoryᵢⱼ=Demandᵢⱼ×Wᵢ

Inventory converted to volume:

$${\sum }_{i} {\sum }_{k} {v}_{i} \cdot {x}_{ijk} \leq {C}_{j}$$

In addition, the constraints layer 718 enforces eligibility constraints to restrict placement of clusters in eligible locations, and demand fulfillment constraints, formulated as follows:

$${\sum }_{j} {x}_{ijk} = {D}_{ik}$$

In some embodiments, nonlinear relationships between demand and inventory are approximated using linear transformations; such linearization enables efficient solution using linear programming solvers.

In some examples, the solver layer 720 executes the optimization using linear programming approach to generate an optimized plan. The solver layer 720 formulates a linear formula using data from the objective function layer 716 and the constraints layer 718. The solver layer 720 executes a multi-stage process for determining optimal inventory placement and positioning decisions. The algorithms of the solver layer 720 iteratively improves the solution until arriving at an optimal solution that minimizes the weight combinations of the user-selectable objectives and while satisfying the various constraints 104. In particular, in some embodiments, the solver iteratively computes allocation values for decision variables xᵢⱼₖ outlined above. The clustering reduces the number of decision variables, enabling solution within practical time and memory constraints.

In some examples, the output module 708 includes various output layers such as a positioning output layer 722, a placement output layer 724, and a demand allocation output layer 726. In other examples, there may be fewer output layers, and in some examples, there may be additional output layers. The output module 708 provides a comprehensive inventory placement and positioning plan that determines an optimal configuration of the fulfillment network.

In some examples, the positioning output layer 722 outputs a specified quantity of each item or cluster to be stored at each fulfillment center location. In some examples, the optimization model 112 prioritizes placing lower quantities of items or clusters across more locations.

In some examples, the placement output layer 724 outputs a specified list of items or clusters that should be kept at each fulfillment center locations in order to define the assortment of items available at each facility.

In some examples, the demand allocation output layer 726 outputs how customer demand from each geographic region should be fulfilled by each fulfillment center.

In some embodiments, the output module further includes a declustering process that maps cluster-level outputs to individual items. In some examples, cluster-level quantities are distributed among items based on proportional allocation using forecasted or historical demand, and item-level placement and positioning decisions are generated for downstream execution systems.

Overall, referring to FIG. 7, the architecture 700 improves computing system performance by reducing dimensionality of the optimization problem via clustering, enabling linear programming formulations through constraint transformations, reducing memory and processing requirements relative to item-level optimization models, and enabling scalable execution through parallel demand forecasting.

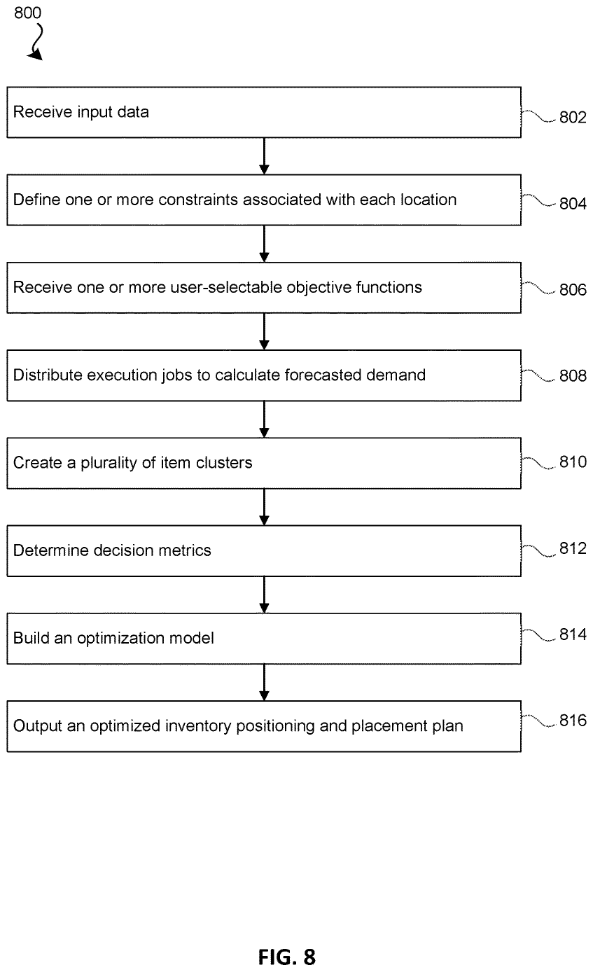

FIG. 8 illustrates an example method 800 for optimizing positioning and placement of inventory items. The method may be executed by one or more computing systems, such as the system 100 described in FIG. 1.

At operation 802, input data is received from one or more data sources. In some embodiments, the input data includes an inventory collection including a set of items, a set of fulfillment locations, a set of demand regions corresponding to geographic areas, and historical and/or forecast-related data associated with item demand. In some examples, demand data is provided at a granular level (e.g., zip code or store level) and may be aggregated into regional groupings, and item attributes include volume, category, velocity, and eligibility constraints. In some such examples, location attributes include throughput capacity, storage capacity, and handling capabilities. The input data may be retrieved from one or more databases, including the item database 122, location database 124, and destination database 126.

At operation 804, one or more constraints associated with each fulfillment location are defined. In some embodiments, constraints include throughput constraints, representing a maximum number of units that can be processed within a time period, as well as volume constraints, representing a maximum storage capacity and item handling constraints, representing eligibility of items at specific locations. In some examples, constraints are configurable via a user interface, and may include additional business rules such as item affinity, exclusion rules, and consistency constraints across planning periods.

At operation 806, a selection of one or more objective functions is received. In some embodiments, objective functions include minimizing shipping cost based on distance between locations and demand regions, minimizing delivery time, and maximizing utilization of available storage capacity. In some examples, multiple objectives are combined using a weighted scoring function, and weights may be configurable by a user. Additional objective components may include penalties for unmet demand and rewards for co-locating frequently co-ordered items.

At operation 808, forecasted demand is generated for each item. In some embodiments, a plurality of execution jobs is distributed across multiple computing systems, and each computing system processes demand forecasting for a subset of items, regions, or time granularities (e.g., daily, weekly, monthly). This distribution is further described in FIG. 5. Results are aggregated to produce region-level demand forecasts. This parallelization reduces overall computation time and enables scalable processing of large datasets.

At operation 810, items are grouped into clusters based on attribute tags. In some embodiments, each item is assigned tags across multiple dimensions, including volume classification, location eligibility, product category (pyramid classification), and velocity classification derived from forecasted demand.

Additionally, items sharing identical or substantially similar combinations of tags are grouped into a cluster. This clustering reduces the dimensionality of the optimization problem. Cluster granularity may be configurable to balance computational efficiency and solution accuracy.

At operation 812, decision variables are defined for the optimization model. In some embodiments, each decision variable represents a quantity of demand associated with a cluster allocated from a fulfillment location to a demand region, and decision variables are defined at a cluster level rather than an individual item level. In some examples, the number of decision variables is reduced relative to an item-level formulation, improving computational efficiency.

At example operation 814, an optimization model that optimizes for the selected user-selectable objective function(s) based at least in part on the clustered items, the forecasted demand for each item, and decision metrics.

At operation 814, an optimization model is constructed and solved. In some embodiments, the optimization model is formulated as a linear program, and includes an objective function based on distance, penalties, and affinity rewards, as well as constraints including throughput, volume, and eligibility constraints. In some examples, inventory levels are approximated from demand using a supply-duration parameter, volume constraints are derived by converting estimated inventory into cubic volume requirements, and nonlinear relationships are approximated using linear transformations to enable efficient solving. The optimization model is solved using a solver to determine cluster-level allocation quantities.

At operation 816, an optimized inventory positioning and placement plan is generated. In some embodiments, the output initially specifies quantities at a cluster level, and a declustering process maps cluster-level quantities to individual items. In some examples, item-level quantities are determined based on proportional allocation using forecasted demand or historical demand. The resulting plan specifies which items are placed at each fulfillment location, as well as quantities of each item at each location. The generated plan may be output to a user interface, stored in a database, or transmitted to downstream fulfillment and replenishment systems.

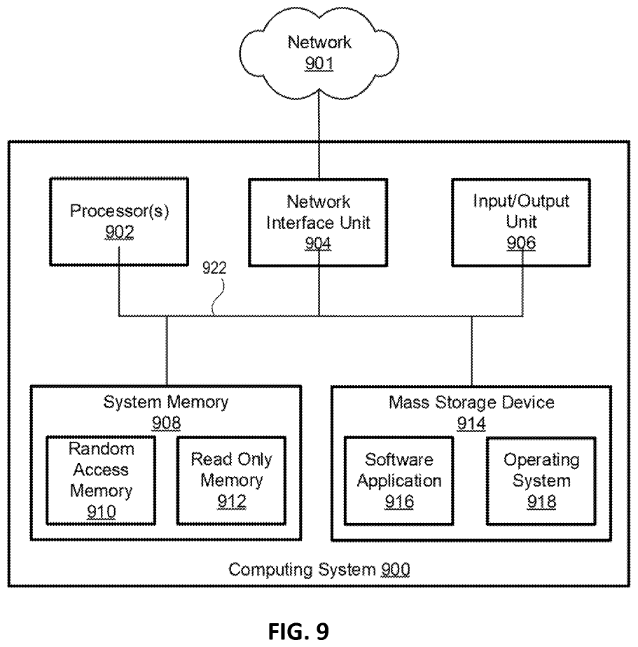

FIG. 9 illustrates an example block diagram of a virtual or physical computing system 900. One or more aspects of the computing system 900 can be used to implement the processes described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

Referring to FIGS. 1-9 generally, it is noted that the various embodiments described herein improve operation of computing systems in a variety of ways. As discussed above, improvements are achieved by reducing the dimensionality of optimization variables from item-level to cluster-level representations, thereby reducing computational complexity from O(N_items×N_locations×N_regions) to O(N_clusters×N_locations×N_regions). This enables linear programming formulations in place of nonlinear formulations through constraint transformations, and allows use of more efficient polynomial-time solution approaches. This reformulation also enables parallel execution of demand forecasting tasks across distributed computing resources, thereby reducing end-to-end processing latency, while reducing memory requirements associated with storing and solving large-scale optimization models. These improvements reflect technical improvements to computer-based optimization systems.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of inventory allocation levels across a multi-node supply chain, technologies disclosed herein are applicable to data and methods for inventory positioning generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented method for generating an inventory positioning and placement plan, the method comprising:
receiving, by one or more processors, input data defining:
a set of items;
a set of fulfillment locations; and
demand data associated with a plurality of geographic regions;
generating, by the one or more processors, forecasted demand for the set of items at the plurality of geographic regions by distributing forecasting tasks across a plurality of computing systems executing in parallel;
transforming, by the one or more processors, the set of items into a reduced set of item clusters based on combinations of attribute tags including at least volume, location eligibility, and velocity derived from the forecasted demand, thereby reducing a dimensionality of an optimization problem;
defining, by the one or more processors, one or more decision variables representing allocation quantities of the reduced set of item clusters between fulfillment locations and geographic regions;
constructing, by the one or more processors, a linear optimization model comprising:
the one or more decision variables;
one or more constraints including throughput constraints and storage capacity constraints, wherein the storage capacity constraints are derived by determining approximated inventory levels as a function of forecasted demand and converting the approximated inventory levels into volume constraints; and
an objective function based at least in part on a distance-based cost metric;
solving, by the one or more processors, the linear optimization model to generate cluster-level allocation quantities;
mapping, by the one or more processors, the cluster-level allocation quantities to item-level placement quantities using a declustering process; and
outputting the inventory positioning and placement plan,
wherein transforming the set of items into the reduced set of item clusters reduces computational resource utilization associated with solving the linear optimization model.

2. The method of claim 1, wherein the attribute tags further include a product category classification.

3. The method of claim 1, wherein clustering comprises grouping items having identical combinations of attribute tags across multiple dimensions.

4. The method of claim 1, wherein generating forecasted demand comprises partitioning forecasting tasks based on at least one of item subsets, geographic regions, and time granularities.

5. The method of claim 1, wherein the storage capacity constraints are derived using a weeks-of-supply parameter applied to the forecasted demand.

6. The method of claim 1, wherein the objective function further includes:
a penalty term associated with unmet demand; and
a reward term associated with co-location of frequently co-ordered items.

7. The method of claim 6, further comprising predicting item affinity based on co-ordering behavior and incorporating the predicted item affinity into the reward term.

8. The method of claim 1, wherein mapping the cluster-level allocation quantities comprises distributing quantities among items within each cluster based on proportional demand allocation.

9. A computing system, comprising:
at least one processor; and
at least one memory storing instructions that, when executed by the at least one processor, cause the computing system to:
receive input data defining a set of items, a set of fulfillment locations, and demand data associated with a plurality of geographic regions;
generate forecasted demand by distributing forecasting tasks across a plurality of computing systems executing in parallel;
transform the set of items into a reduced set of item clusters based on combinations of attribute tags including at least volume, location eligibility, and velocity derived from the forecasted demand, thereby reducing a dimensionality of an optimization problem;
define one or more decision variables representing allocation quantities of the reduced set of item clusters between fulfillment locations and geographic regions;
construct a linear optimization model including:
the one or more decision variables;
one or more constraints including throughput constraints and storage capacity constraints derived from the forecasted demand using a linear approximation of inventory levels; and
an objective function based at least in part on a distance-based cost metric;
solve the linear optimization model to generate cluster-level allocation quantities;
map the cluster-level allocation quantities to item-level placement quantities; and
output an inventory positioning and placement plan,
wherein the transformation of the set of items into the reduced set of item clusters reduces computational complexity relative to an item-level optimization model.

10. The system of claim 9, wherein the attribute tags further include a product category classification.

11. The system of claim 9, wherein clustering comprises grouping items having identical combinations of attribute tags.

12. The system of claim 9, wherein the forecasting tasks are partitioned across items, geographic regions, and time granularities.

13. The system of claim 9, wherein the storage capacity constraints are derived using a demand-to-inventory transformation based on a supply-duration parameter.

14. The system of claim 9, wherein the objective function includes a penalty for unmet demand and a reward for co-location of frequently co-ordered items.

15. The system of claim 14, wherein the computing system is further configured to predict item affinity based on co-ordering behavior.

16. The system of claim 9, wherein mapping comprises distributing cluster-level quantities to individual items based on the forecasted demand.

17. The system of claim 9, wherein clustering reduces a number of decision variables by at least an order of magnitude relative to an item-level formulation.

18. A platform for generating an inventory positioning and placement plan, comprising:
a computing device;
a plurality of data storages; and
a network server in communication with the computing device and the plurality of data storages,
wherein the computing device is configured to:
receive input data defining a set of items, a set of fulfillment locations, and demand data associated with a plurality of geographic regions;
generate forecasted demand using distributed computing resources executing forecasting tasks in parallel;
transform the set of items into a reduced set of item clusters based on combinations of attribute tags, thereby reducing dimensionality of an optimization problem;
construct and solve a linear optimization model defined using decision variables representing allocation quantities of the reduced set of item clusters;
generate cluster-level allocation quantities based on the linear optimization model;
map the cluster-level allocation quantities to item-level placement quantities; and
output the inventory positioning and placement plan,
wherein the platform is configured to reduce memory usage and execution time associated with solving the linear optimization model relative to an item-level formulation.

19. The platform of claim 18, wherein the computing device is further configured to store the inventory positioning and placement plan in one of the plurality of data storages.

20. The platform of claim 18, wherein the computing device is further configured to initiate movement of inventory items among fulfillment locations based on the inventory positioning and placement plan.
